(19) United States
(12) Patent Application Publication
(10) Pub. No.: US 2017/0087850 A1
(43) Pub. Date: Mar. 30, 2017

(54) Passive Meniscus Pressure Stabilization During Shutdown Of An Ink Jet Printing System

(71) Applicant: Dover Europe Sàrl, Vernier (CH)

(72) Inventors: Sven Kerpe, Linkenheim-Hochstetten (DE); Scott Gordon Page, Alstead, NH (US); Michael Nizguretski, Karlsruhe (DE)

(21) Appl. No.: 15/271,119

(22) Filed: Sep. 20, 2016

Related U.S. Application Data
(60) Provisional application No. 62/233,258, filed on Sep. 25, 2015.

(51) Int. Cl. B41J 2/165

(52) U.S. Cl. CPC B41J 2/16526

(57) ABSTRACT

Systems and techniques relating to passive meniscus stabilization during shutdown for ink jet printing systems are described. A described system includes a tank to store ink; a print head including a nozzle plate defining nozzles, the print head coupled with the tank to supply ink to the nozzles; an active pressure control system coupled with the tank and the print head, the active pressure control system maintaining a pressure level in the print head during an operational state of the printing system; and a passive pressure control system coupled with the print head to hydrostatically moderate the pressure level in the print head during a shutdown state of the printing system.

### CROSS REFERENCE TO RELATED APPLICATION

This patent document claims the benefit of priority from U.S. provisional application No. 62/233,258 entitled “PASSIVE MENISCUS PRESSURE STABILIZATION DURING SHUTDOWN OF AN INK JET PRINTING SYSTEM” and filed on Sep. 25, 2015, which is incorporated herein by reference in its entirety.

### BACKGROUND

Ink jet printing systems include a print head having small nozzles through which ink is ejected in a controlled manner to form an image on an adjacent substrate. Meniscuses are formed within the nozzles creating an air-ink boundary. A vacuum can be actively applied to the print head during active printing operations to control ink flow through the nozzles. Ink in ink jet printing systems can be provided by a supply line from a remote ink supply.

### SUMMARY

The present disclosure includes systems and techniques relating to passive meniscus stabilization during shutdown for ink jet printing systems. A printing system can include a tank to store ink; a print head including a nozzle plate defining nozzles, the print head coupled with the tank to supply ink to the nozzles; an active pressure control system coupled with the tank and the print head, the active pressure control system maintaining a pressure level in the print head during an operational state of the printing system; and a passive pressure control system coupled with the print head to hydrostatically moderate the pressure level in the print head during a shutdown state of the printing system. The passive pressure control system can include a channel, the channel including an inlet situated on a first leg of the channel and an outlet situated on a second leg of the channel, where the inlet of the channel is coupled with the print head. The outlet of the channel can be situated at a predetermined distance below the nozzle plate, the predetermined distance selected to cause ink within the channel to generate pressure during the shutdown state of the printing system to maintain the pressure level in the print head developed by the active pressure control system during the operational state of the printing system.

The printing system and other implementations can include one or more of the following features. The predetermined distance can be selected in accordance with Δp=−g*ρ*Δh, where Δp is a meniscus pressure in the nozzles, g is gravity, ρ is ink density, and Δh is the predetermined distance. The channel includes a bent tubal structure having an inner diameter selected to maintain the pressure level in the print head to within a predetermined range during the shutdown state of the printing system. The passive pressure control system can include a collection tray to collect ink from the outlet of the channel. The passive pressure control system can include a bottle to collect ink from the outlet of the channel. In some implementations, the channel includes a u-shaped channel. In some implementations, the channel includes a L-shaped channel.

Implementations can include a controller configured to purge ink through the print head to fill the channel to a predetermined ink level. The printing system can include a controller. The printing system can include a first valve coupled with the tank and an inlet of the print head; and a second valve coupled with an outlet of the print head and the inlet of the channel. The controller can be configured to open the first valve during a purge operation, open the second valve during the purge operation, and purge ink during the purge operation through the outlet of the print head to fill the channel at least until ink within the channel reaches the outlet of the channel. The controller can be configured to open the first valve during the operational state of the printing system, and to close the second valve during the operational state of the printing system. The controller can be configured to push a first amount of ink through the print head and the channel during the purge operation, and to push a second amount of ink through the print head and the channel during a cleaning procedure. In some implementations, the first amount of ink is less than the second amount of ink. In some implementations, the second valve is a normally open (NO) valve. In some implementations, the first valve is a normally closed (NC) valve. In some implementations, the tank includes a header-tank.

In some implementations, the tank includes an open-air tank. The print head can include an inlet and an outlet. The active pressure control system can include a first pump coupled with the inlet of the print head and the open-air tank; and a second pump coupled with the outlet of the print head and the open-air tank. In some implementations, the print head includes a port, and the printing system includes a first valve coupled with the port and the active pressure control system; and a second valve coupled with the port and the passive pressure control system. The printing system can include an ink level sensor coupled with the outlet of the channel.

A printing system technique can include performing a purge operation to purge ink through a print head to fill a channel of a passive pressure control system to a predetermined ink level, where the passive pressure control system is coupled with the print head to hydrostatically moderate a pressure level in the print head during a shutdown state of the printing system. The technique can include operating an active pressure control system to maintain the pressure level in the print head during an operational state of the printing system. The predetermined ink level can be selected to cause ink within the channel to generate pressure during the shutdown state of the printing system to maintain the pressure level in the print head developed by the active pressure control system during the operational state of the printing system.

The printing system techniques and other implementations can include one or more of the following features. The print head can include a nozzle plate defining nozzles. The predetermined ink level can be based on a distance selected in accordance with Δp=−g*ρ*Δh, wherein Δp is a meniscus pressure in the nozzles, g is gravity, ρ is ink density, and Δh is the distance between the predetermined ink level and the nozzle plate. The channel can include a bent tubal structure having an inner diameter selected to maintain the pressure level in the print head to within a predetermined range during the shutdown state of the printing system. The technique can include causing a first valve to open during the operational state of the printing system, the first valve coupled between the print head and the active pressure control system; and causing a second valve to close during the operational state of the printing system, the second valve coupled between the print head and the passive pressure control system. The technique can include detecting a shutdown event; and causing, in response to the shutdown event, the second valve to open.

Operating the active pressure control system can include operating a pump to generate a negative pressure within a header-tank. Operating the active pressure control system can include operating a first pump and a second pump, where the first pump is coupled with an inlet of the print head and an open-air tank, and where the second pump is coupled with an outlet of the print head and the tank. Performing the purge operation can include using a ink level sensor to detect whether ink is present at the predetermined ink level. The technique can include pushing a first amount of ink through the print head and the channel during the purge operation; and pushing a second amount of ink through the print head and the channel during a cleaning operation.

A passive pressure control system can include a passive pressure control structure to couple with a print head of a printing system to hydrostatically moderate a pressure level in the print head during a shutdown state of the printing system. The print head can include a nozzle plate defining nozzles. The printing system can include an active pressure control system to maintain a pressure level in the print head during an operational state of the printing system. The passive pressure control structure can include a channel that contains: (i) an inlet to couple with the print head, the inlet situated on a first leg of the channel and (ii) and an outlet situated on a second leg of the channel. The outlet of the channel is configured to be at a predetermined distance below the nozzle plate, the predetermined distance selected to cause ink within the channel to generate pressure during the shutdown state of the printing system to maintain the pressure level in the print head developed by the active pressure control system during the operational state of the printing system.

The passive pressure control system and other implementations can include one or more of the following features. The channel can include a bent tubal structure having an inner diameter selected to maintain the pressure level in the print head to within a predetermined range during the shutdown state of the printing system. The channel can include a u-shaped channel. The channel can include a L-shaped channel, and wherein the inlet of the channel is located on a bottom portion of the L-shaped channel. The passive pressure control structure can include an air gap coupled with the outlet of the channel to allow in air at an ambient pressure. Implementations can include a bottle to collect ink from the outlet, the bottle coupled with the outlet via hosing. Implementations can include a collection tray to collect ink from the outlet. Implementations can include a T-fitting to couple the passive pressure control structure with a port of the print head.

In some implementations, a printing system can include a header-tank to store ink; an active pressure control system coupled with the header-tank to maintain a pressure level in the header-tank during an operational state of the printing system; a first valve coupled with the header-tank; a print head comprising an inlet, an outlet, and a nozzle plate defining nozzles, the print head coupled with the first valve through the inlet of the print head to supply ink to the nozzles; a second valve coupled with the outlet of the print head; and a passive pressure control system coupled with the second valve to hydrostatically moderate a pressure level in the print head during a shutdown state of the printing system, wherein the passive pressure control system comprises a channel, the channel comprising an inlet situated on a first leg of the channel and an outlet situated on a second leg of the channel, wherein the inlet of the channel is coupled with the outlet of the print head via the second valve, wherein the outlet of the channel is situated at a predetermined distance below the nozzle plate, the predetermined distance selected to cause ink within the channel to generate pressure during the shutdown state of the printing system to maintain the pressure level in the print head developed by the active pressure control system during the operational state of the printing system.

In some implementations, a printing system can include a header-tank to store ink; a first valve, where the first valve is closed during a shutdown state of the apparatus; a print head including nozzles defined on a nozzle plate, an inlet to supply ink to the nozzles, and an outlet, where the inlet is coupled with the header-tank via the first valve; a second valve, where the second valve is open during the shutdown state of the apparatus; and a u-shaped channel coupled with the outlet of the print head via the second valve. The u-shaped channel can be configured to maintain a pressure within the print head to within a predetermined range during the shutdown state of the apparatus to inhibit air intake through the nozzles and inhibit ink leakage through the nozzles.

Implementations of the subject matter of the present disclosure can result in one or more of the following advantages. A described technology can prevent nozzle air intake during shutdown. A described technology can prevent nozzle ink leakage during shutdown. A described technology can enable a passive process control system to operate without power during shutdown. For example, pressure within a print head can be maintained after shutdown without requiring power to do so which can extend the lifetime of a printing system.

### BRIEF DESCRIPTION OF THE DRAWINGS

FIG. 1 shows an ink flow architecture of an example of a printing system that includes an active pressure control system and a passive pressure control system.

FIG. 2A shows a manifold cross-section of an example of a print head and associated connections.

FIG. 2B show a cross-section of an example of a nozzle plate of the print head of FIG. 2A.

FIGS. 3A, 3B, 3C, 3D, and 3E show a cross-section of an example of the print head of FIG. 2A at different states in a printing system without a passive pressure control system.

FIG. 4 shows a graph of an example of the meniscus pressure within the print head of FIG. 2 without passive pressure stabilization before and after the transition to the cooling shutdown state of FIG. 3E.

FIG. 5 shows a graph of the valve states of an example of a printing system with passive pressure stabilization before and after a transition to a shutdown state.

FIG. 6 shows a graph of an example of the meniscus pressure within the print head of a printing system with passive pressure stabilization before and after a transition to the shutdown state of FIG. 5.

FIG. 7 shows a flowchart of an example of a process associated with a printing system with passive pressure stabilization.

FIG. 8 shows a high-level architecture of an example of a printing system with a dual pathway active pressure control system and a passive pressure control system.

FIG. 9 shows a high-level architecture of an example of a printing system that includes an active pressure control system, a passive pressure control system, and a single port print head.

FIG. 10 shows a cross-section of an example of a passive pressure control system.

FIG. 11 shows a cross-section of an example of a passive pressure control system with a L-shaped channel within a printing system.

### DETAILED DESCRIPTION

Printing systems such as Drop on Demand (DoD) printing systems with an ink supply system based on a header-tank can use a passive pressure control system to stabilize pressure within their print heads during shutdown. Stabilizing print head pressure can inhibit ink leakage through the print head nozzles, inhibit the sucking of air-bubbles through the print head nozzles, or both when the printer is turned off.

In printing systems without passive meniscus pressure stabilization requiring heated ink, system shutdown causes the ink within the print head to cool. Accordingly, the print head experiences increasing negative pressure as the ink cools. As the building negative pressure exceeds the maximum negative pressure which the meniscuses within the nozzles can hold, the meniscuses break and air is sucked in to the print head through the nozzles. After turning on the printer, the printer may have to undergo time consuming maintenance to rid the printer of the air from the print head. The cause of the high negative pressure after shutdown can be the damper inside of the print head. The damper can be built with a thin membrane foil, which covers a manifold in the top of the print head. Passive meniscus pressure stabilization can maintain pressure within the damper of a print head to inhibit air intake and ink leakage.

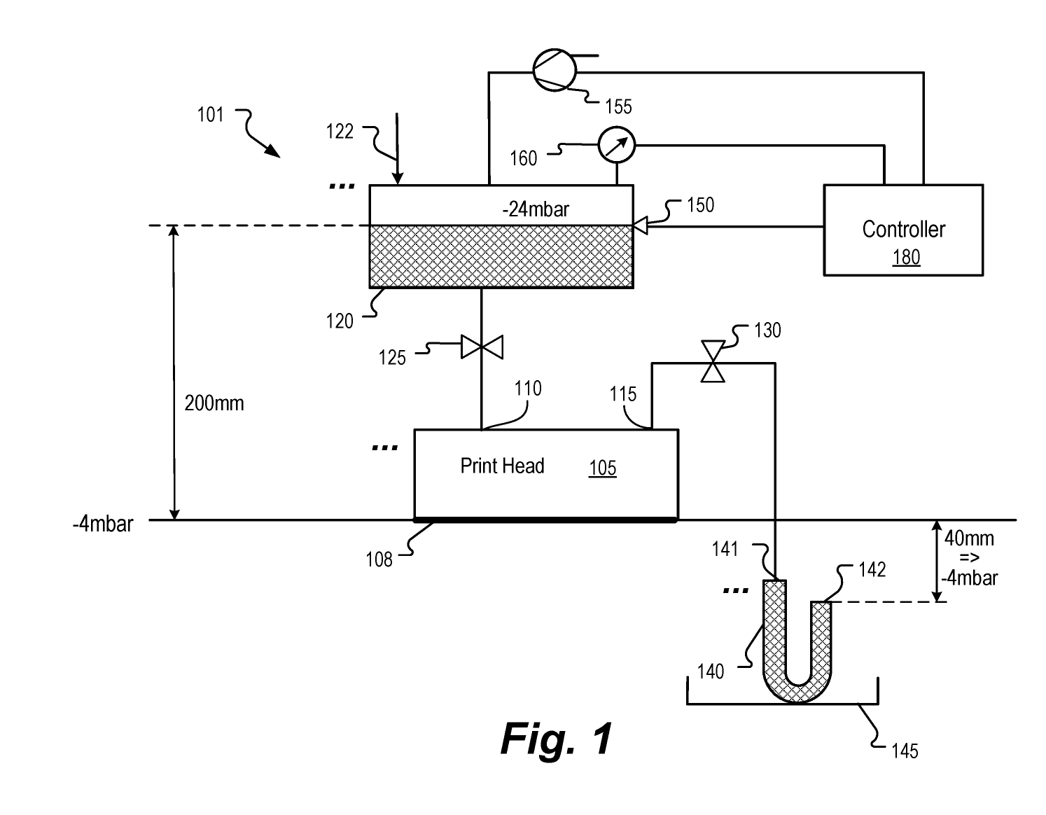

FIG. 1 shows an ink flow architecture of an example of a printing system 101 that includes an active pressure control system and a passive pressure control system. The printing system 101 includes a header-tank 120 and a print head 105 that is pressurized to a negative pressure via the active pressure control system during an operational state. The printing system 101 includes a passive pressure control system which can include a channel such as a u-shaped channel 140 to stabilize pressure within the print head 105 during a shutdown state. Note that the printing system 101 can include multiple sets of one or more header-tanks, one or more print heads, and one or more u-shaped channels, e.g., one set per ink color. Further note that flexible hosing can interconnect various components within the printing system 101 to allow the print head 105 to move about a print surface, and in some implementations, components can be included to condition the ink, e.g., degasser, heater and/or filter systems.

The header-tank 120 stores ink for the print head 105. The header-tank 120 includes an ink refill port 122 and an ink level sensor 150. A controller 180 can monitor the ink level using readings from the ink level sensor 150. Pressure within the header-tank 120 is controlled by an active pressure control system which includes a vacuum controller 155 and a pressure sensor 160. The active pressure control system, via the controller 180, can use the pressure sensor 160 to sense pressure within the header-tank 120. The active pressure control system, via the controller 180, can use the vacuum controller 155 to adjust the vacuum within the header-tank 120, which can create a negative pressure within the header-tank 120.

The print head 105 includes an inlet 110 and an outlet 115 for ink. The inlet 110 of the print head 105 is coupled with the header-tank 120. A valve 125 is mounted between the header-tank 120 and the print head 105. The valve 125 is a normally closed (NC) valve, which ensures that the valve 125 is closed in case of a shutdown to prevent ink flow to the print head 105.

A passive pressure control system can moderate the pressure level within the print head 105 during a shutdown. Shutdown can include (i) the state of transitioning from a power-on state to a power-off state and (ii) the power-off state. In some implementations, shutdown can refer to a termination of printing services, but other system components such as a user-input console or status display can still be in a power-on state. The passive pressure control system is coupled with the outlet 115 of the print head 105. A valve 130 is mounted between the passive pressure control system and the outlet 115 of the print head 105. The valve 130 is a normally open (NO) valve, which ensures that the valve 130 is open during shutdown. An example of this valve 130 is a Bürkert Fluid Control Systems 2080-182864 valve, available from Christian Bürkert Werke GmbH & Co. KG of Ingelfingen, Germany. Other types of valves can also be used.

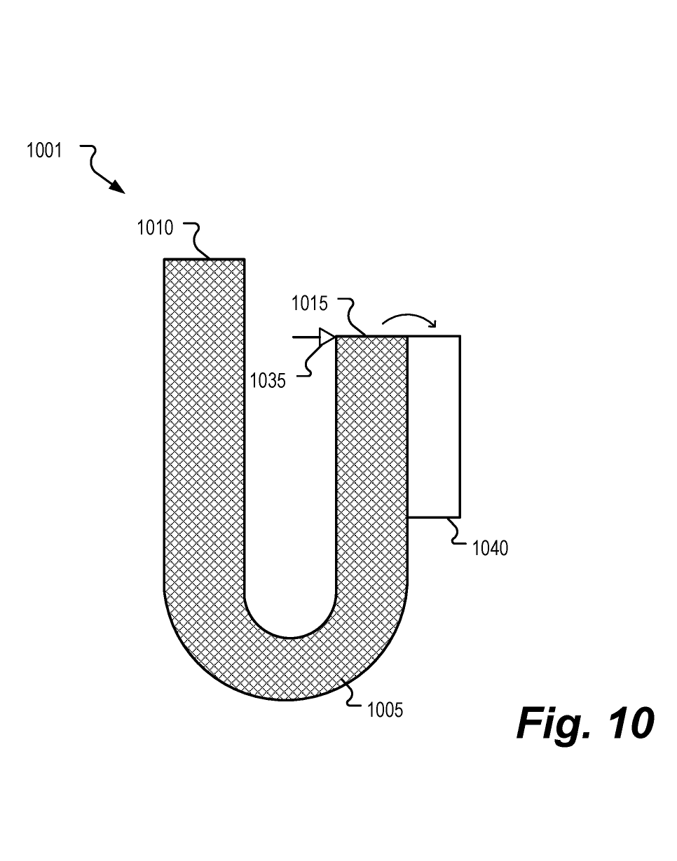

The passive pressure control system includes a channel that is formed like a horseshoe bend, which can be referred to as a u-shaped channel 140. The u-shaped channel 140 includes an inlet-side leg that includes an inlet 141 and an outlet-side leg that includes an outlet 142. At the end of the u-shaped channel 140 is the outlet 142 for draining ink into a collection tray 145. In this example, the ends (e.g., inlet 141 and outlet 142) of the u-shaped channel 140 are at different heights relative to the nozzle plate 108. However, the ends can be at different heights in different implementations, and in general, the height of the outlet 142 is what matters. The height of the outlet 142 is important because the outlet is under ambient pressure conditions and therefore in a pressure balance with the menisci in the nozzles, which can generate the meniscus pressure hydrostatically. In some implementations, the u-shape channel 140 can be built (at least in part) with tubing that is part of the passive pressure control, such as described in further detail below in connection with FIG. 10.

The ink level at the outlet 142 of the u-shaped channel 140 is situated below the nozzle plate 108. The height difference between the ink level at the outlet 142 and the nozzle plate 108 generates the meniscus pressure during shutdown. The height difference required can be computed from the formula Δp=−g*ρ*Δh, where Δp represents the meniscus pressure, g is gravity, ρ is ink density, and Δh is the height difference. In this example, the pressure within the header-tank 120 is at −24 mbar during an operational state and the meniscus pressure at the nozzle plate 108 is at −4 mbar during the operational state. To have the u-shaped channel 140 generate −4 mbar at the nozzle plate 108 given an ink density of 1 kg/dm³, the required height difference Δh is approximately 40 mm. Thus, the surface plane of the outlet 142 is 40 mm below the nozzle plate 108. Other height differences are possible given different combinations of design parameters, e.g., required header-tank pressure, ink density, meniscus pressure, nozzle size, ink surface tension, hydrostatic pressure at the nozzles, etc.

The passive pressure control system can drain ink in case of increasing pressure inside the print head 105 to ensure a constant ink level at the outlet 142 of the u-shaped channel 140. In case of a decreasing pressure inside the print head 105, the u-shaped channel 140 can passively supply ink to the print head 105. One or more design parameters of the passive pressure control system can be selected to maintain the pressure level within the print head 105 during a shutdown to within a predetermined range. For example, the inner diameter of the u-shaped channel 140 can be selected to maintain a meniscus pressure within the print head 105 in a defined range, e.g., +/−1 mbar. Selecting a bigger diameter can minimize changes in the ink level and therefore changes to the pressure.

The printing system 101, via the controller 180, can perform a purge operation to prime the passive pressure control system for a subsequent shutdown. In some implementations, the printing system 101 can purge ink through the outlet 115 of the print head 105 during a purge operation included in a startup procedure. This purge operation fills the u-shaped channel 140 with ink until the ink level reaches the outlet 142 of the u-shaped channel 140. Note that both of the valves 125, 130 are open during the purge operation. In some implementations, a predetermined amount of ink is purged to ensure that the ink level reaches the outlet 142 of the u-shaped channel 140. The predetermined amount of ink can be estimated based on the amount of ink that the print head 105 can hold and the amount of ink to be removed. In some implementations, the predetermined amount of ink is programmed into the controller 180. In some implementations, the purge is included within a cleaning procedure where the controller 180 rids the printing system 101 of old ink by pushing an additional amount of ink out of the outlet 142 and into the collection tray 145.

A print head can be positioned horizontally (as shown in FIG. 1) or vertically. If the print head is vertically positioned, the meniscus pressure will change over the height of the print head. In this vertical case, the target meniscus pressure can be the average pressure, which will be in the middle of the print head. The pressure changes at different points about the print head's nozzle plate can be within a tolerance range to ensure appropriate jetting behavior.

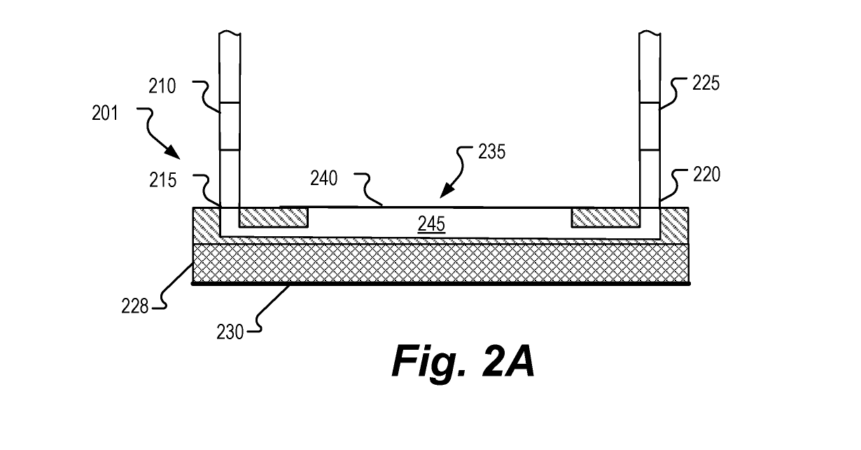

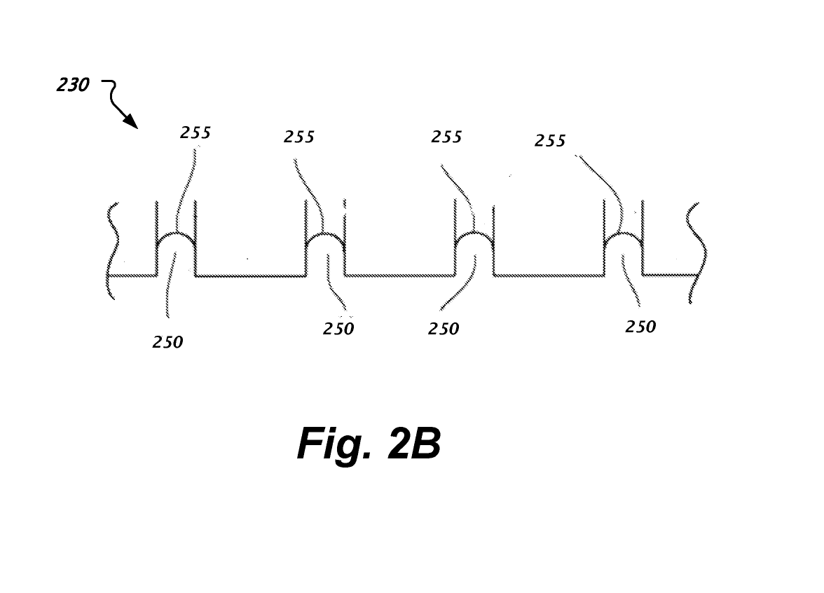

FIG. 2A shows a manifold cross-section of an example of a print head 201 and associated connections. An inlet valve 210 provides ink to the print head 201 via an inlet 215. An outlet valve 225 controls ink flow from and to the print head 201 via an outlet 220. The print head 201 includes a damper 235. The damper 235 includes a damper membrane 240 and a manifold 245. The manifold 245 is situated on a nozzle plate 230. The print head 201 can include one or more pathways to allow ink to flow between the manifold 245 and the nozzle plate 230. In some implementations, the damper membrane 240 is a thin foil that is glued to cover and seal the manifold 245. The outside of the damper membrane 240 is exposed to ambient pressure. The manifold 245 is connected to the inlet 215 and the outlet 220 of the print head 201. The region 228 between the nozzle plate 230 and the manifold cross-section, e.g., bottom of manifold 245, can include one or more ink distribution pathways, filters, nozzle chambers, piezo elements, head electronics, or a combination thereof.

FIG. 2B shows a portion of a cross-section of an example of a nozzle plate 230 of the print head 201 of FIG. 2A. A print head 201 can jet ink from one or more arrays of ink jet nozzles 250 defined in the nozzle plate 230 of the print head 201. When the print head 201 is not jetting ink, ink meniscuses 255 in the nozzles 250 are maintained by a vacuum that pulls the ink towards the manifold 245, balancing the capillary action between the ink and the ink channel and the fluid head pressure of the ink system. The vacuum is selected to be within a desired range, e.g., based on the properties of the ink, the nozzles 250, and the jetting frequency of the nozzles 250.

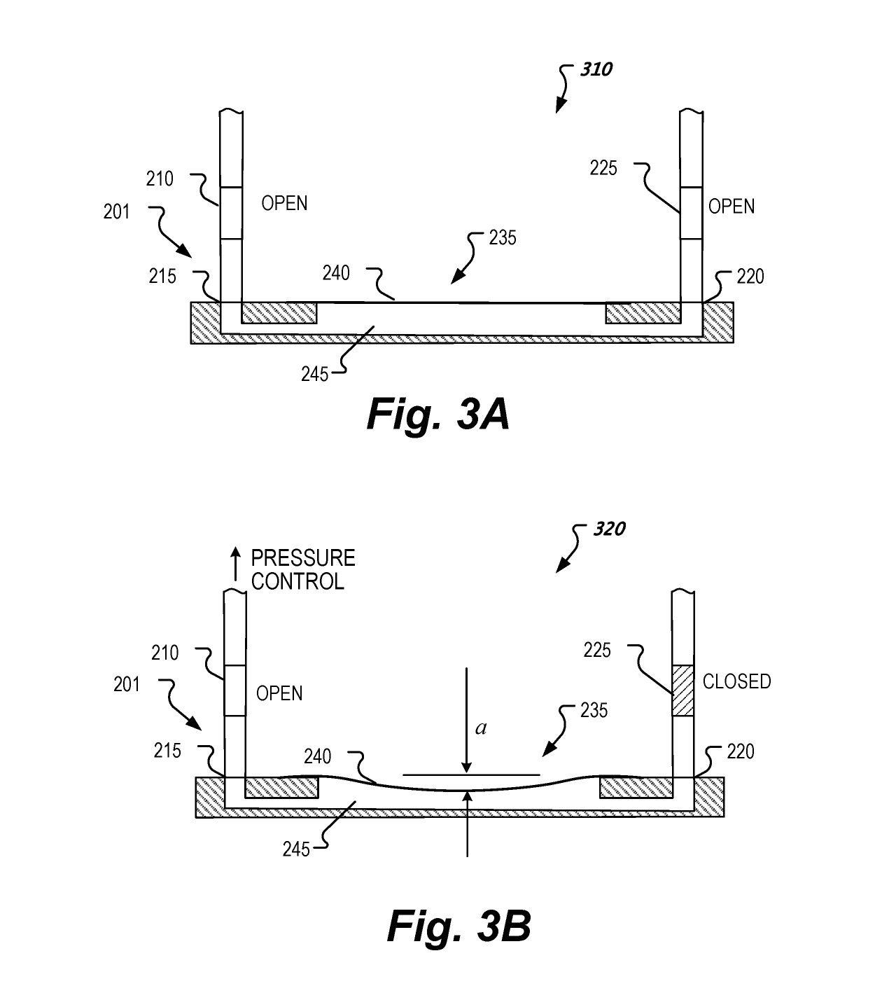

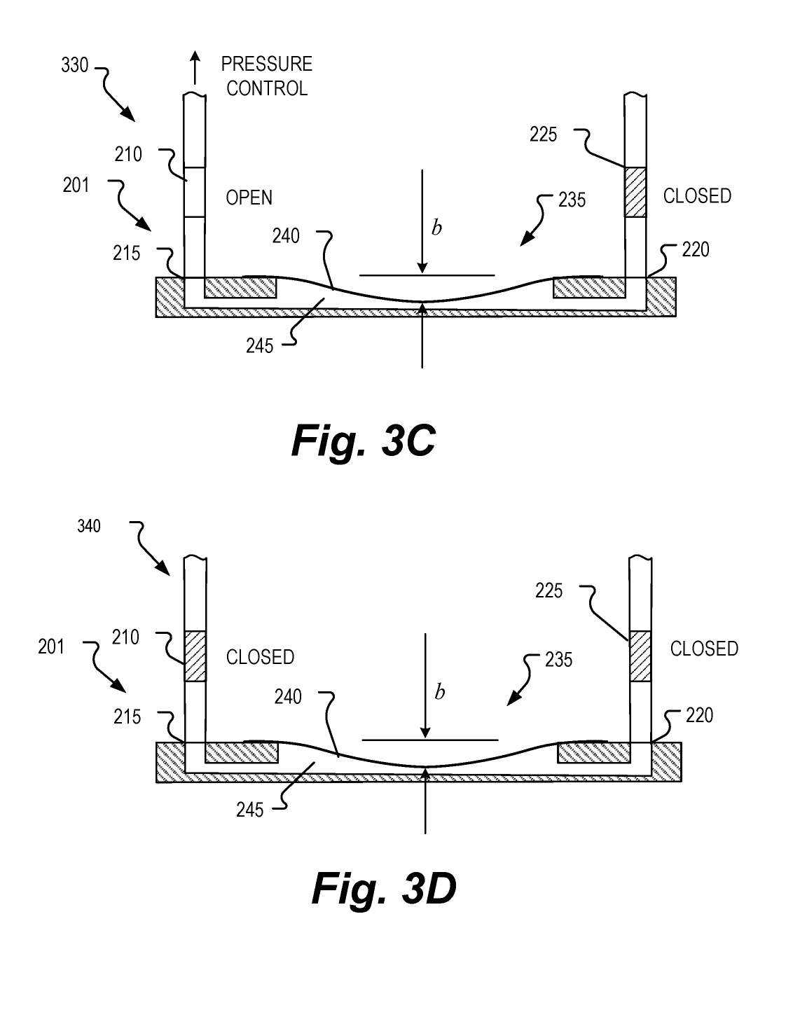

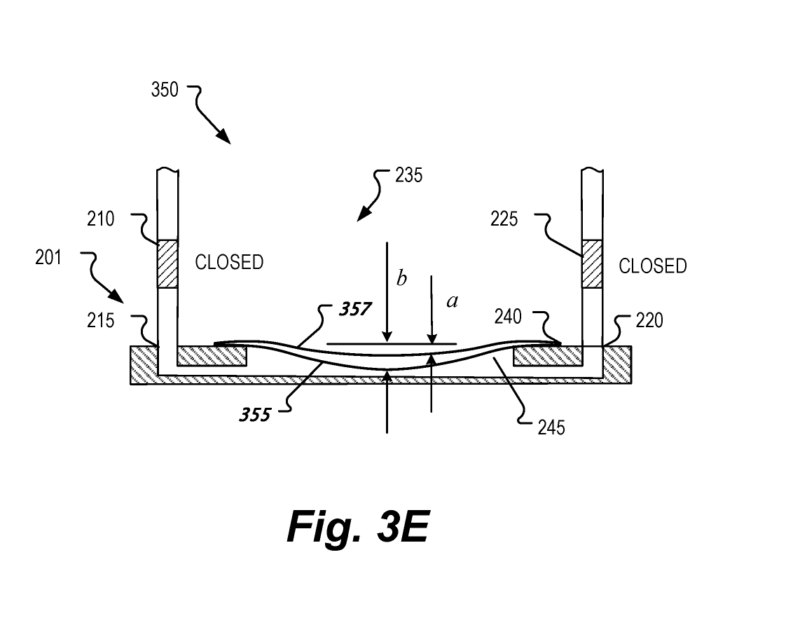

FIGS. 3A, 3B, 3C, 3D, and 3E show a cross-section of an example of the print head 201 of FIG. 2A at different states in a printing system without use of a passive pressure control system. In these examples, the outlet 220 of the print head 201 is not coupled with a passive pressure control system.

FIG. 3A shows a cross-section of the print head 201 in an initial state 310 where both of the valves 210, 225 associated with the print head 201 are open, and active pressure control is not applied. Further, the manifold 245 is at an ambient pressure and at an ambient temperature. Under these conditions the damper membrane 240 is flat.

FIG. 3B shows a cross-section of the print head 201 in a start-up state 320 where the inlet valve 210 is open, the outlet valve 225 is closed, and active pressure control is applied via the inlet valve 210. The manifold 245 is currently at an ambient temperature. Ambient pressure is applied at the outside of the damper membrane 240. Meniscus pressure is applied by the active pressure control inside the tubes and the manifold 245. The pressure being applied is a negative pressure. This pressure difference bends the damper membrane 240. The deformation of the damper membrane 240 in the vertical direction is shown as distance “a” in the figure. Note that the volume inside the manifold 245 decreases in this start-up state 320 due to the application of negative pressure.

FIG. 3C shows a cross-section of the print head 201 in a print-ready state 330 where the inlet valve 210 is open, the outlet valve 225 is closed, and active pressure control is applied via the inlet valve 210. The manifold 245 is under the meniscus pressure. In this example, the manifold 245 has warmed to a jetting temperature. Further, the damper membrane 240 expanded due to thermal expansion. The deformation of the damper membrane 240 in the vertical direction is shown as distance “b” in the figure. Note that the volume inside the manifold 245 has additionally decreased when compared to the start-up state 320. Note that to achieve a good jetting result, the ink has to warm and stay at or within a certain range of the jetting temperature. In some implementations, a printing system can include a heating system to heat the ink to the jetting temperature. In some implementations, the print head 201 includes a heating system. Heating of the ink can start in the start-up state 320. In some implementations, an operational state can include print-ready state 330, a printing state, or both.

FIG. 3D shows a cross-section of the print head 201 in an initial shutdown state 340 where the inlet valve 210 is closed and the outlet valve 225 is closed. Immediately after a turn off event, the print head 201 and the ink inside are at the jetting temperature. The pressure of the manifold 245 is still at the meniscus pressure because both of the valves 210, 225 are closed and effectively creates a closed system for the time being.

FIG. 3E shows a cross-section of the print head 201 in a cooling shutdown state 350 where the inlet valve 210 is closed and the outlet valve 225 is closed. The print head 201 and the ink will cool down to the ambient temperature. The deformation of the damper membrane 240 from FIG. 3D is shown by line 355; here the membrane foil is blocked by the fixed volume which fits to a deformation having distance “b” in the figure as measured from a flat membrane position. The deformation of the damper membrane 240 which fits to ambient temperature is shown by line 357; here the membrane foil fits to a deformation having distance “a” in the figure. In general, cooling within a closed system will cause its pressure to decrease. Therefore, the negative pressure inside the manifold 245 will increase. When a critical meniscus breakage pressure is exceeded, the meniscuses 255 within the nozzles 250 will break and air will be sucked in to the manifold 245.

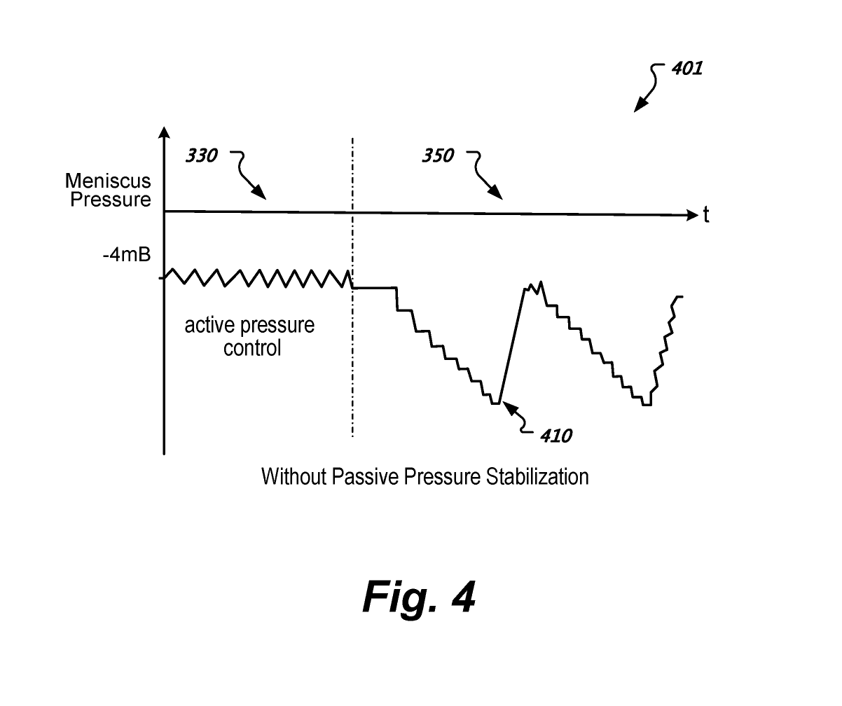

FIG. 4 shows a graph 401 of an example of the meniscus pressure within the print head 201 of FIG. 2 without passive pressure stabilization before and after the transition to the cooling shutdown state 350 of FIG. 3E. In this example, the active pressure control keeps the meniscus pressure within the print head 201 around −4 mbar during the print-ready state 330, in which the system is under active pressure control. After system shutoff, the meniscus pressure decreases. When a critical meniscus breakage pressure 410 is reached, the meniscuses 255 within the nozzles 250 will break and air will be sucked in to the manifold 245. This sucking will increase pressure within the manifold 245 and subsequent cooling will cause another breakage event to occur. In some implementations, the critical meniscus breakage pressure 410 is −45 mbar; other breakage pressures are possible.

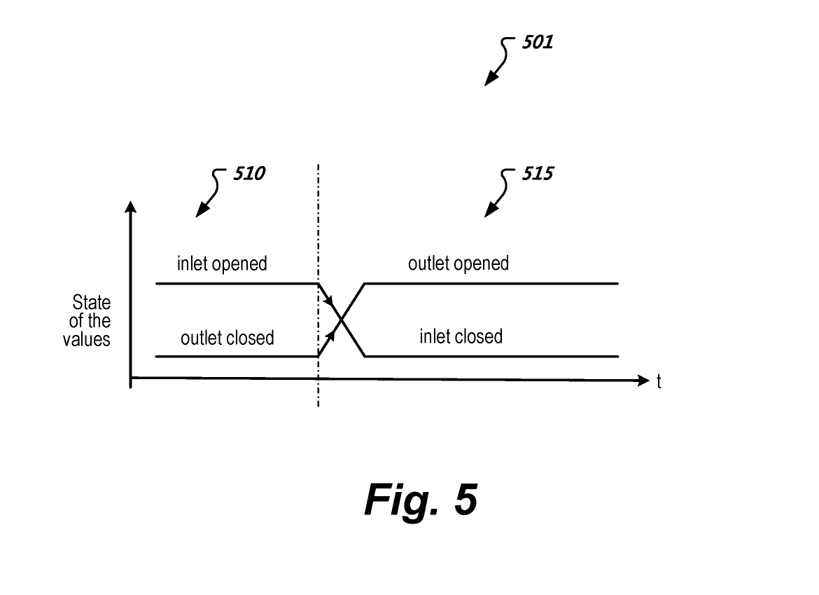

FIG. 5 shows a graph 501 of the valve states of an example of a printing system with passive pressure stabilization before and after a transition to a shutdown state 515. In a powered, print state 510, the inlet valve to the print head from the header-tank is open, and the outlet valve from the print head to the u-shaped channel is closed. In the shutdown state 515, the inlet valve to the print head from the header-tank is closed, and the outlet valve from the print head to the u-shaped channel is open. The opening of the outlet valve 225 enables a u-shaped channel of a passive pressure control system to provide passive pressure stabilization during the shutdown state 515.

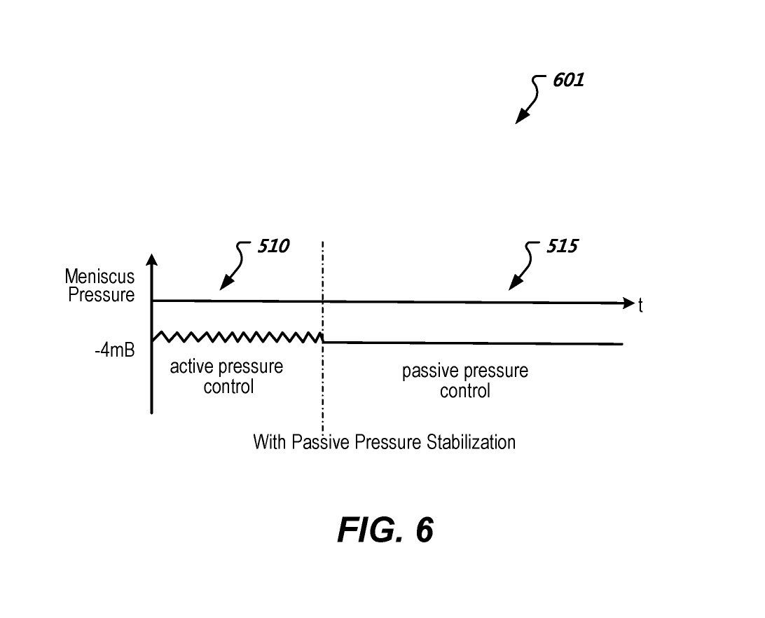

FIG. 6 shows a graph 601 of an example of the meniscus pressure within the print head of a printing system with passive pressure stabilization before and after a transition to the shutdown state 515 of FIG. 5. In the powered, print state 510, active pressure control keeps the meniscus pressure within the print head 201 around −4 mbar. In the shutdown state 515, passive pressure control takes over and acts to maintain the meniscus pressure within the print head. Passive pressure control prevents the meniscus pressure from reaching the critical meniscus breakage pressure.

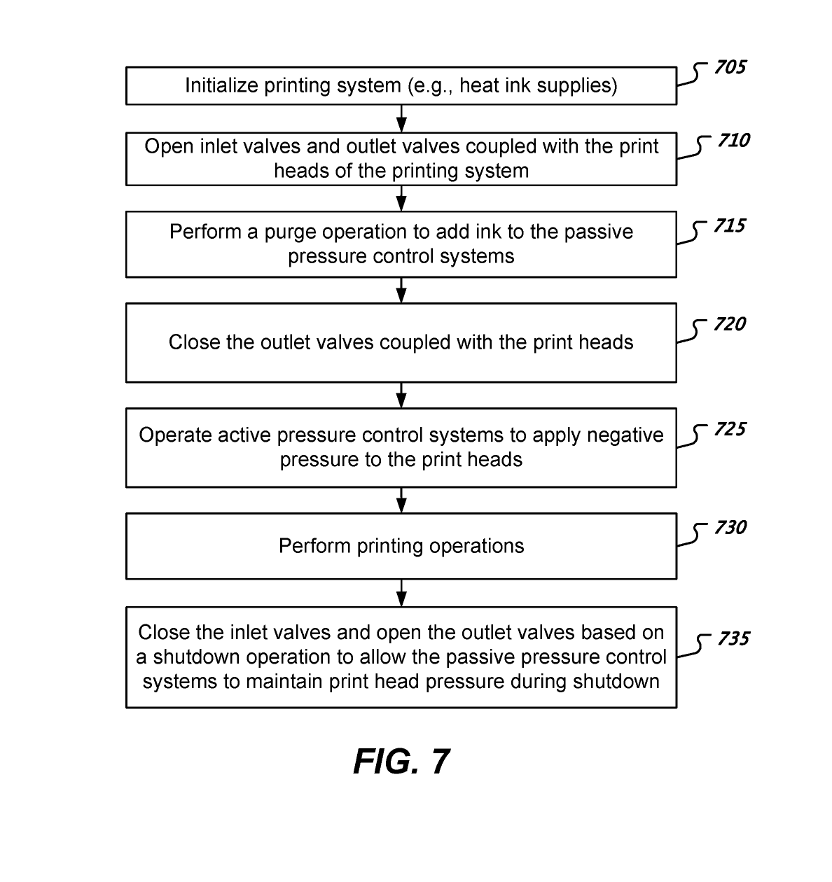

FIG. 7 shows a flowchart of an example of a process associated with a printing system with passive pressure stabilization. At 705, the process initializes a printing system. Initialization can include heating ink supplies, calibrating print head positions, or checking ink levels. Other and different types of initialization operations are possible. This example describes a printing system that includes multiple ink colors, however, this example can be applied to a printing system that includes a single ink color. At 710, the process opens inlet valves and outlet valves coupled with the print heads of the printing system. In some valve implementations, the process provides a voltage to a valve (e.g., normally closed) to cause the valve to switch from a closed state to an opened state. In some valve implementations, the process does not have to provide a voltage to a valve (e.g., normally opened) because the valve is normally opened.

At 715, the process performs a purge operation to add ink to passive pressure control systems. In some implementations, there is a passive pressure control system for each ink color. However, this process can be adapted to apply to a printing system with one passive pressure control system. The process can perform a purge operation on each of the print heads of the printing system. In some implementations, the process causes a predetermined amount of ink to flow from the header-tank into the print head and then into the u-shaped channel of each passive pressure control system. In some implementations, the process causes ink to flow from the header-tank into the print head and then into the u-shaped channel of each passive pressure control system until sensor reading indicates that a predetermined ink level within the u-shaped channel has been reached. At 720, the process closes the outlet valves coupled with the print heads. In some implementations, closing the outlet valves can include applying a voltage to the outlet valves to seal the print heads from their respective passive pressure control systems.

At 725, the process operates active pressure control systems to apply negative pressure to the print heads. Operating an active pressure control system can include adjusting pressure within a header-tank based on pressure sensor readings from the header-tank. Each header-tank can have its own active pressure control system. At 730, the process performs printing operations such as printing images or letters on a substrate such as paper, plastic, or other materials suitable for ink jet printing. Printing operations can include moving the print heads about a surface of a substrate and actuating nozzles within the print heads to deposit ink on the substrate. In some implementations, active pressure control systems are continually monitoring and adjusting pressure as required within the print heads.

At 735, the process closes the inlet valves and opens the outlet valves based on a shutdown operation to allow passive pressure control systems to maintain print head pressure during shutdown. For example, an operator can press a shutdown button on the printing system or send a shutdown command to the printing system from a remote location. In some implementations, closing the inlet valves and opening the outlet valves includes cutting power to the valves. For example, if the inlet valves are NC valves and the outlet valves are NO valves, cutting power to both valve types would cause the NC valves to close and the NO valves to open.

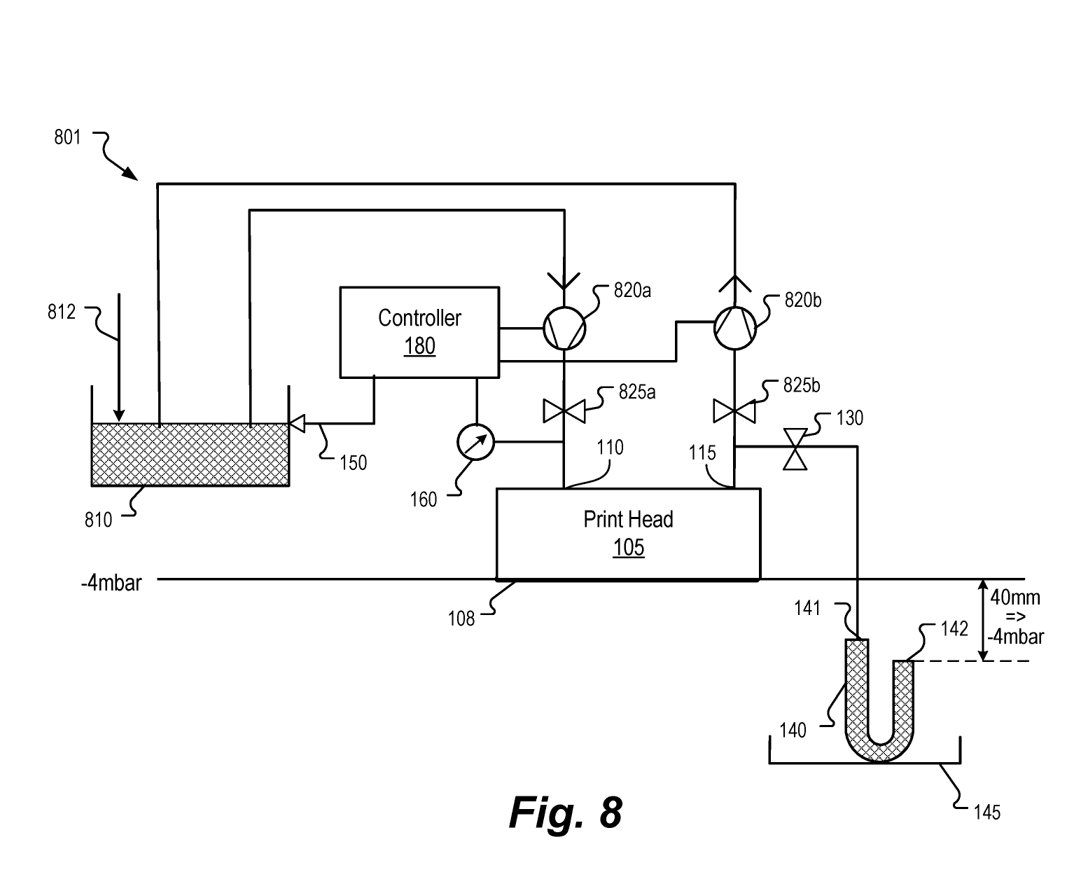

FIG. 8 shows a high-level architecture of an example of a printing system 801 with a dual pathway active pressure control system and a passive pressure control system. This printing system 801 has several similarities to the printing system 101 of FIG. 1. However, in this example, the active pressure control system includes an in-flow pathway and an out-flow pathway for ink recirculation through an open-air tank 810. The in-flow pathway couples with the inlet 110 of the print head 105, and includes a pump 820a and a valve 825a for pumping to the print head 105 from an open-air tank 810. The out-flow pathway couples with the outlet 115 of the print head 105, and includes a pump 820b and a valve 825b for pumping from the print head 105 to the open-air tank 810. The printing system 801 can include an ink refill pathway 812 to replenish ink to the open-air tank 810.

The printing system 801 can include a controller 180 to read sensor inputs from sensors such as a pressure sensor 160 coupled with the in-flow pathway near the inlet 110 of the print head 105 and an ink level sensor 150 coupled with the open-air tank 810. The controller 180 can control the pumps 820a, 820b and their respective valves 825a, 825b. For example, the controller 180 can cycle one of the pumps 805a, 805b faster than the other pump to create the required meniscus pressure during an operational state. Further, the controller 180 can control a valve 130 to engage or disengage the passive pressure control system of the printing system 801. The passive pressure control system can include a channel such as the u-shaped channel 140 of FIG. 1 or a L-shaped channel. Other shapes and types of channels are possible. In some implementations, the passive pressure control system can include a sub tank with an opening at the right height, and in some implementations, a tube can be fixed at the outlet of the tank.

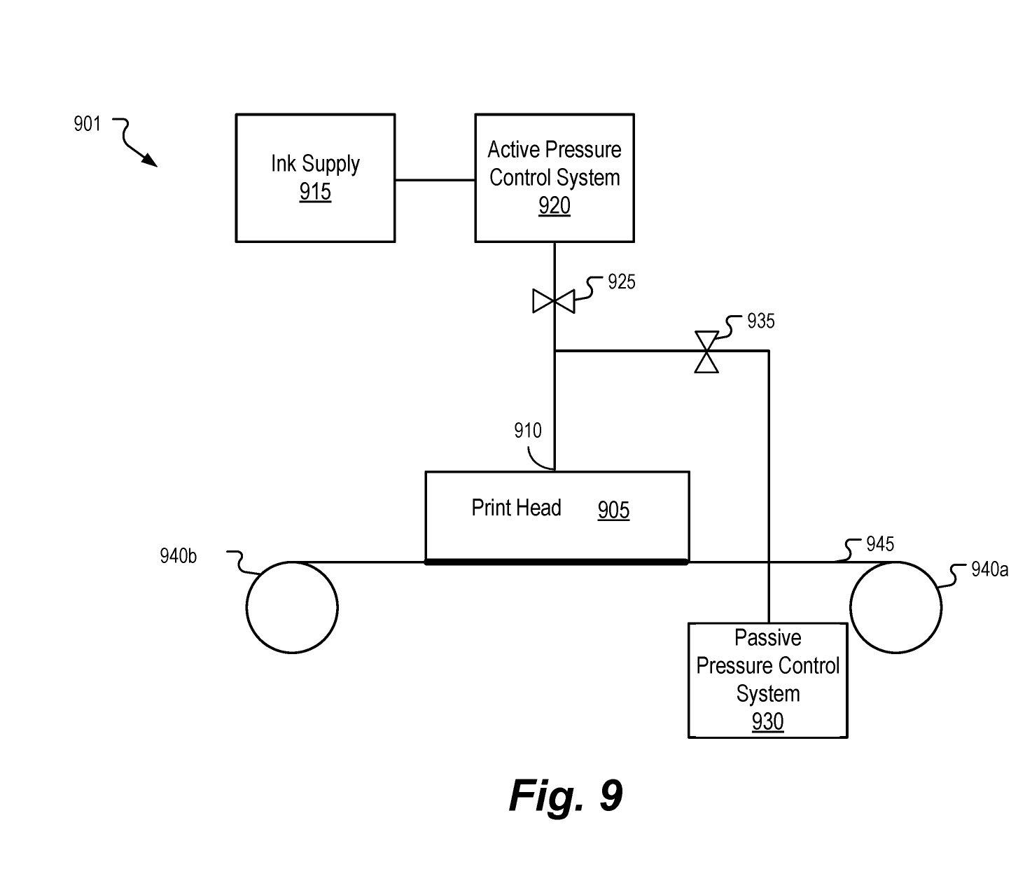

FIG. 9 shows a high-level architecture of an example of a printing system 901 that includes an active pressure control system 920, a passive pressure control system 930 and a single port print head 905. In this example, a print head 905 includes a single port 910 that couples with an ink supply 915, active pressure control system 920 and the passive pressure control system 930. A valve 925 is coupled between the active pressure control system 920 and the print head 905. Another valve 935 is coupled between the passive pressure control system 930 and the print head 905. In some implementations, a T-fitting can be used to interconnect the control systems 920, 930 with the print head 905.

During an operational state, the valves 925, 935 can be operated to allow the ink supply 915 and active pressure control system 920 to supply ink and to provide negative pressure to the print head 905 and to cutoff the passive pressure control system 930 from the print head 905. During a shutdown state, the valves 925, 935 can be operated to cutoff the ink supply 915 and active pressure control system 920 from the print head 905 and to allow the passive pressure control system 930 to moderate the pressure level within the print head 905. In some implementations, the ink supply and active pressure control system 920 includes a header-tank such as the header-tank 120 of FIG. 1. In some implementations, the ink supply 915 includes an open-air tank such as the open-air tank 810 of FIG. 8. In some implementations, the passive pressure control system 930 includes a channel such as the u-shaped channel 140 of FIG. 1, a L-shaped structure, or a bent tubal structure. The bent tubal structure can have an inner diameter selected to maintain the pressure level in the print head to within a predetermined range during the shutdown state of the printing system 901. The printing system 901 can include a controller to operate the active pressure control system 920 and the valves 925, 935. In some implementations, the printing system 901 can include a printing surface 945 where a printing substrate such as paper, plastic, or metal moves from one reel 940a to another reel 940b. As the printing substrate is moving across the printing surface 945, the print head 905 can print an image on the printing substrate.

FIG. 10 shows a cross-section of an example of a passive pressure control system 1001. The passive pressure control system 1001 can include a channel 1005 having an inlet 1010 and an outlet 1015. In some implementations, the channel 1005 can include flexible hosing which interconnects the inlet 1010 and the outlet 1015. In some implementations, the channel 1005 includes a rigid structure such as one formed in plastic or metal, where a u-shaped tubal region is defined between the inlet 1010 and the outlet 1015.

In some implementations, the passive pressure control system 1001 can include an ink level sensor 1035 coupled with the outlet 1015. In some implementations, during a purge operation a controller can purge ink through the channel 1005 and can stop the purge based on a detection of ink at the ink level sensor 1035. In some implementations, the channel 1005 is located outside of a printer, rather than inside the printer, and a height difference between a nozzle plate of a print head and the outlet 1015 is kept sufficient (e.g., within a defined range) to create a required pressure level.

In some implementations, the passive pressure control system 1001 can include a bottle 1040 to collect overflow ink from the outlet 1015. In some implementations, a tube can interconnect the outlet 1015 to the bottle 1040, where the tube, bottle 1040, or both are open to the ambient air pressure. In some implementations, the diameter of a tube coupling the outlet 1015 and the bottle 1040 is wide enough to avoid hydraulic head pressure, e.g., there is an air channel between inner surface of the coupling tube and the ink inside the coupling tube.

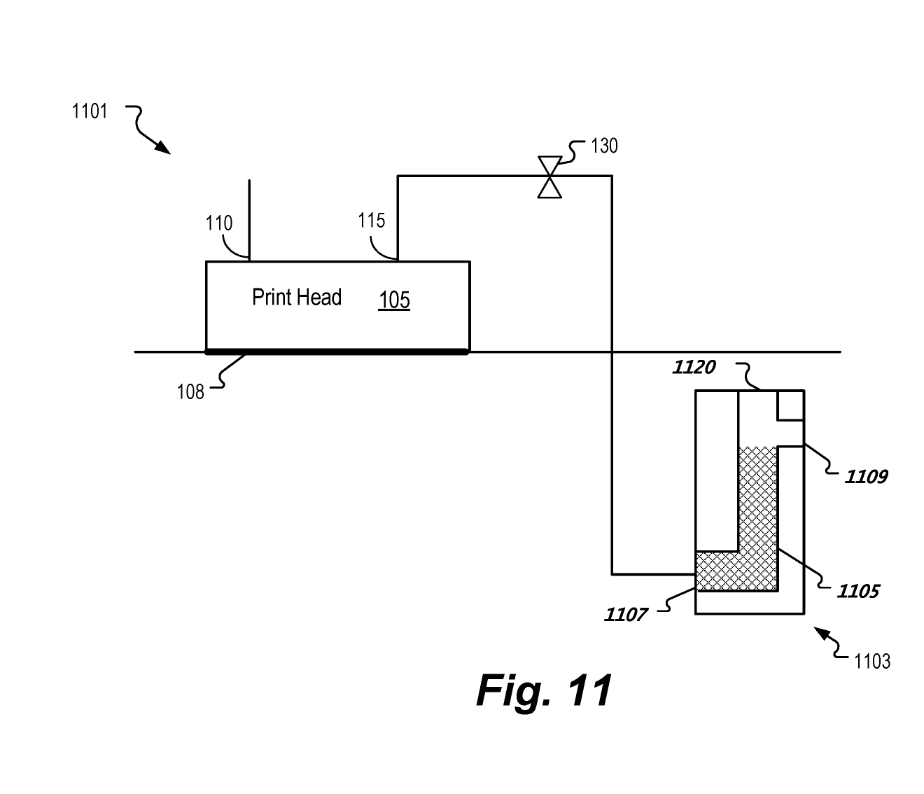

FIG. 11 shows a cross-section of an example of a passive pressure control system 1103 with a L-shaped channel 1105 within a printing system 1101. The printing system 1101 can include a print head 105 coupled with the passive pressure control system 1103 via a valve 130. The passive pressure control system 1103 includes a channel such as a L-shaped channel 1105. In some implementations, the L-shaped channel 1105 is defined within a rigid structure. In some implementations, the L-shaped channel 1105 is defined in a flexible structure. The L-shaped channel 1105 includes an inlet 1107 at the bottom of the L-shaped channel 1105. The L-shaped channel 1105 includes an outlet 1109. If ink exceeds the level of the outlet 1109, then ink can flow out of the L-shaped channel 1105 and into a collection tray or a bottle. Once filled with ink, the level of the outlet 1109 relative to the nozzle plate 108 create the required pressure for passive pressure stabilization. In some implementations, the L-shaped channel 1105 can include an air gap 1120 to allow ink to flow out of the outlet 1109 and into an enclosed ink container.

In some implementations, a printing system can include a header-tank to store ink; an active pressure control system coupled with the header-tank to maintain a pressure level in the header-tank during an operational state of the printing system; a first valve coupled with the header-tank; a print head comprising an inlet, an outlet, and a nozzle plate defining nozzles, the print head coupled with the first valve through the inlet of the print head to supply ink to the nozzles; a second valve coupled with the outlet of the print head; and a passive pressure control system coupled with the second valve to hydrostatically moderate a pressure level in the print head during a shutdown state of the printing system, wherein the passive pressure control system comprises a channel, the channel comprising an inlet situated on a first leg of the channel and an outlet situated on a second leg of the channel, wherein the inlet of the channel is coupled with the outlet of the print head via the second valve, wherein the outlet of the channel is situated at a predetermined distance below the nozzle plate, the predetermined distance selected to cause ink within the channel to generate pressure during the shutdown state of the printing system to maintain the pressure level in the print head developed by the active pressure control system during the operational state of the printing system.

In some implementations, a printing system can include a header-tank to store ink; a first valve, where the first valve is closed during a shutdown state of the apparatus; a print head including nozzles defined on a nozzle plate, an inlet to supply ink to the nozzles, and an outlet, where the inlet is coupled with the header-tank via the first valve; a second valve, where the second valve is open during the shutdown state of the apparatus; and a u-shaped channel coupled with the outlet of the print head via the second valve. The u-shaped channel can be configured to maintain a pressure within the print head to within a predetermined range during the shutdown state of the apparatus to inhibit air intake through the nozzles and inhibit ink leakage through the nozzles.

While this specification contains many specifics, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Other embodiments fall within the scope of the following claims.

What is claimed is:

1. A printing system comprising:
a tank to store ink;
a print head comprising a nozzle plate defining nozzles, the print head coupled with the tank to supply ink to the nozzles;
an active pressure control system coupled with the tank and the print head, the active pressure control system maintaining a pressure level in the print head during an operational state of the printing system; and
a passive pressure control system coupled with the print head to hydrostatically moderate the pressure level in the print head during a shutdown state of the printing system, wherein the passive pressure control system comprises a channel, the channel comprising an inlet situated on a first leg of the channel and an outlet situated on a second leg of the channel, wherein the inlet of the channel is coupled with the print head,
wherein the outlet of the channel is situated at a predetermined distance below the nozzle plate, the predetermined distance selected to cause ink within the channel to generate pressure during the shutdown state of the printing system to maintain the pressure level in the print head developed by the active pressure control system during the operational state of the printing system.

2. The printing system of claim 1, wherein the predetermined distance is selected in accordance with Δp=−g*ρ*Δh, wherein Δp is a meniscus pressure in the nozzles, g is gravity, and ρ is ink density, and Δh is the predetermined distance.

3. The printing system of claim 1, wherein the channel comprises a bent tubal structure having an inner diameter selected to maintain the pressure level in the print head to within a predetermined range during the shutdown state of the printing system.

4. The printing system of claim 1, wherein the passive pressure control system comprises a collection tray to collect ink from the outlet of the channel.

5. The printing system of claim 1, wherein the passive pressure control system comprises a bottle to collect ink from the outlet of the channel.

6. The printing system of claim 1, wherein the channel comprises a u-shaped channel.

7. The printing system of claim 1, comprising:
a controller configured to purge ink through the print head to fill the channel to a predetermined ink level.

8. The printing system of claim 1, wherein the printing system comprises:
a first valve coupled with the tank and an inlet of the print head; and
a second valve coupled with an outlet of the print head and the inlet of the channel.

9. The printing system of claim 8, comprising:
a controller configured to (i) open the first valve during a purge operation, (ii) open the second valve during the purge operation, and (iii) purge ink during the purge operation through the outlet of the print head to fill the channel at least until ink within the channel reaches the outlet of the channel.

10. The printing system of claim 9, wherein the controller is configured to open the first valve during the operational state of the printing system, and to close the second valve during the operational state of the printing system.

11. The printing system of claim 9, wherein the controller is configured to push a first amount of ink through the print head and the channel during the purge operation, and to push a second amount of ink through the print head and the channel during a cleaning procedure, wherein the first amount of ink is less than the second amount of ink.

12. The printing system of claim 8, wherein the second valve is a normally open (NO) valve, and wherein the first valve is a normally closed (NC) valve.

13. The printing system of claim 8, wherein the tank comprises a header-tank.

14. The printing system of claim 1, wherein the tank comprises an open-air tank, wherein the print head comprises an inlet and an outlet, and wherein the active pressure control system comprises:
a first pump coupled with the inlet of the print head and the open-air tank; and
a second pump coupled with the outlet of the print head and the open-air tank.

15. The printing system of claim 1, wherein the print head comprises a port, and wherein the printing system comprises:
a first valve coupled with the port and the active pressure control system; and
a second valve coupled with the port and the passive pressure control system.

16. The printing system of claim 1, comprising:
an ink level sensor coupled with the outlet of the channel.

17. A method associated with a printing system, the method comprising:
performing a purge operation to purge ink through a print head to fill a channel of a passive pressure control system to a predetermined ink level, wherein the passive pressure control system is coupled with the print head to hydrostatically moderate a pressure level in the print head during a shutdown state of the printing system; and
operating an active pressure control system to maintain the pressure level in the print head during an operational state of the printing system,
the predetermined ink level being selected to cause ink within the channel to generate pressure during the shutdown state of the printing system to maintain the pressure level in the print head developed by the active pressure control system during the operational state of the printing system.

18. The method of claim 17, wherein the print head comprises a nozzle plate defining nozzles, wherein the predetermined ink level is based on a distance selected in accordance with Δp=−g*ρ*Δh, wherein Δp is a meniscus pressure in the nozzles, g is gravity, ρ is ink density, and Δh is the distance between the predetermined ink level and the nozzle plate.

19. The method of claim 17, wherein the channel comprises a bent tubal structure having an inner diameter selected to maintain the pressure level in the print head to within a predetermined range during the shutdown state of the printing system.

20. The method of claim 17, comprising:
causing a first valve to open during the operational state of the printing system, the first valve coupled between the print head and the active pressure control system; and
causing a second valve to close during the operational state of the printing system, the second valve coupled between the print head and the passive pressure control system.

21. The method of claim 20, comprising:
detecting a shutdown event; and
causing, in response to the shutdown event, the second valve to open.

22. The method of claim 17, wherein operating the active pressure control system comprises operating a pump to generate a negative pressure within a header-tank.

23. The method of claim 17, wherein operating the active pressure control system comprises operating a first pump and a second pump, wherein the first pump is coupled with an inlet of the print head and an open-air tank, and wherein the second pump is coupled with an outlet of the print head and the tank.

24. The method of claim 17, wherein performing the purge operation comprises using a ink level sensor to detect whether ink is present at the predetermined ink level.

25. The method of claim 17, comprising:
pushing a first amount of ink through the print head and the channel during the purge operation; and
pushing a second amount of ink through the print head and the channel during a cleaning operation.

26. An apparatus comprising:
a passive pressure control structure to couple with a print head of a printing system to hydrostatically moderate a pressure level in the print head during a shutdown state of the printing system, wherein the print head comprises a nozzle plate defining nozzles, wherein the printing system comprises an active pressure control system to maintain a pressure level in the print head during an operational state of the printing system,
wherein the passive pressure control structure comprises a channel, the channel comprising (i) an inlet to couple with the print head, the inlet situated on a first leg of the channel and (ii) and an outlet situated on a second leg of the channel,
wherein the outlet of the channel is configured to be at a predetermined distance below the nozzle plate, the predetermined distance selected to cause ink within the channel to generate pressure during the shutdown state of the printing system to maintain the pressure level in the print head developed by the active pressure control system during the operational state of the printing system.

27. The apparatus of claim 26, wherein the channel comprises a bent tubal structure having an inner diameter selected to maintain the pressure level in the print head to within a predetermined range during the shutdown state of the printing system.

28. The apparatus of claim 26, wherein the channel comprises a u-shaped channel.

29. The apparatus of claim 26, wherein the channel comprises a L-shaped channel, and wherein the inlet is located on a bottom portion of the L-shaped channel.

30. The apparatus of claim 26, wherein the passive pressure control structure comprises an air gap coupled with the outlet to allow in air at an ambient pressure.

31. The apparatus of claim 26, comprising:
a bottle to collect ink from the outlet, the bottle coupled with the outlet via hosing.

32. The apparatus of claim 26, comprising:
a collection tray to collect ink from the outlet.

33. The apparatus of claim 26, comprising:
a T-fitting to couple the passive pressure control structure with a port of the print head.

34. A printing system comprising:
a header-tank to store ink;
an active pressure control system coupled with the header-tank to maintain a pressure level in the header-tank during an operational state of the printing system;
a first valve coupled with the header-tank;
a print head comprising an inlet, an outlet, and a nozzle plate defining nozzles, the print head coupled with the first valve through the inlet of the print head to supply ink to the nozzles;
a second valve coupled with the outlet of the print head; and
a passive pressure control system coupled with the second valve to hydrostatically moderate a pressure level in the print head during a shutdown state of the printing system, wherein the passive pressure control system comprises a channel, the channel comprising an inlet situated on a first leg of the channel and an outlet situated on a second leg of the channel, wherein the inlet of the channel is coupled with the outlet of the print head via the second valve,
wherein the outlet of the channel is situated at a predetermined distance below the nozzle plate, the predetermined distance selected to cause ink within the channel to generate pressure during the shutdown state of the printing system to maintain the pressure level in the print head developed by the active pressure control system during the operational state of the printing system.

35. The printing system of claim 34, wherein the second valve is a normally open (NO) valve, and wherein the first valve is a normally closed (NC) valve.

36. The printing system of claim 34, wherein the passive pressure control system comprises a collection tray to collect ink from the outlet of the channel.

37. The printing system of claim 34, wherein the channel comprises a u-shaped channel or a L-shaped channel.

38. The printing system of claim 34, comprising:
a controller configured to purge ink through the outlet of the print head to fill the channel to a predetermined ink level.

39. The printing system of claim 34, comprising:
a controller configured to (i) open the first valve during a purge operation, (ii) close the second valve during the purge operation, and (iii) to purge ink during the purge operation through the outlet of the print head to fill the channel at least until ink within the channel reaches the outlet of the channel.

40. A printing system comprising:
a header-tank to store ink;
a first valve, wherein the first valve is closed during a shutdown state of the printing system;
a print head comprising nozzles situated on a nozzle plate, an inlet to supply ink to the nozzles, and an outlet, wherein the inlet is coupled with the header-tank via the first valve;
a second valve, wherein the second valve is open during the shutdown state of the printing system; and
a u-shaped channel coupled with the outlet of the print head via the second valve, wherein the u-shaped channel is configured to maintain a pressure within the print head to within a predetermined range during the shutdown state of the printing system to inhibit air intake through the nozzles and inhibit ink leakage through the nozzles.

41. The printing system of claim 40, comprising:
a controller configured to purge ink through the outlet of the print head to fill the u-shaped channel to a predetermined ink level.

42. The printing system of claim 40, comprising:
a collection tray to collect ink from an outlet of the u-shaped channel.
